(19) United States
(12) Patent Application Publication
(10) Pub. No.: US 2010/0036683 A1
(43) Pub. Date: Feb. 11, 2010

(54) DIAGRAMMING TOOL FOR VEHICLE INSURANCE CLAIMS

(76) Inventor: Andrew J. LOGAN, Amesbury, MA (US)

Correspondence Address: LAHIVE & COCKFIELD, LLP;FLOOR 30, SUITE 3000, ONE POST OFFICE SQUARE, BOSTON, MA, 02109, US

(21) Appl. No.: 12/186,235

(22) Filed: Aug. 5, 2008

(51) Int. Cl. G06Q 40/00

(52) U.S. Cl. 705/4

(57) ABSTRACT

A method to use a diagramming tool software application is provided. The diagramming tool software application enables an insured to generate a graphical representation of an incident to be submitted along with an insurance claim application form. The method provided herein streamlines the claim application process, and reduces errors stemming from the insurance adjuster being required to associate the drawings with the claims, and/or re-create the drawings in a more legible and/or transferable format.

### FIELD OF THE INVENTION

The present invention relates to the motor vehicle insurance claims industry, and more particularly a computer-implemented method for submitting a vehicle insurance claim application form related to an incident along with a graphical representation of the incident in electronic form, over a network connection such as the Internet, to a computerized data server of one or more insurance providers.

### BACKGROUND

Insurance industry statistics report that there are over 35 million automobile accidents in the United States per year, and that the insurance claims industry spends in excess of $100 billion per year on personal injury settlements, property damage settlements, and claims adjusting expenses, all relating to automobile accidents. Most of the insurance companies that participate in auto coverage insurance currently have online services that enable an insured to submit an insurance claim application related to an incident. However, the insured is still required to submit a drawing of the incident to the insurance company separately from the online submission. The adjuster for the insurance company is then required to combine the drawing with the claim application, either physically or by re-creating the drawing electronically, or scanning the drawing, for later association with the claim application. As used herein, the term “incident” encompasses accidents, collisions and crashes involving individuals, pedestrians, motor vehicle drivers, motor vehicles, and/or static objects.

The present invention addresses a need to further streamline the insurance claim application process.

### SUMMARY

In accordance with one embodiment of the present invention, a computer implemented method for submission of a motor vehicle insurance claim relating to an incident to one or more insurance service providers is provided. The method includes receiving an insurance claim application form containing information concerning the incident. The method further includes receiving a graphical representation of the incident in electronic form prepared using a diagramming software tool. The graphical representation includes at least one representation of an insured individual or a vehicle of the insured individual. The insurance claim application form and the graphical representation of the incident are stored as a completed insurance claim application. The completed insurance claim application is submitted to the one or more insurance service providers.

In accordance with aspects of the present invention, a computer implemented storage medium is provided. The storage medium stores a graphical diagramming tool for generating a graphical representation of a motor vehicle incident and an insurance claim application tool for filling out an insurance claim application form. The graphical diagramming tool includes a mapping tool for generating a diagram of a location of the motor vehicle incident and a shapes tool for generating one or more icons representing one or more objects present at the location of the motor vehicle incident. The one or more objects include signs, motor vehicles, people, natural objects, or man-made objects. Therein the graphical diagramming tool interacts with the insurance claim application tool.

In accordance with aspects of the present invention a computer implemented method of providing a photograph of an object at a geographical location on a display device is provided. The method includes providing a graphical representation of the geographical location on the display device. The graphical representation includes one or more icons representing one or more still objects present at the geographical location, the one or more objects comprising signs, natural objects, or man-made objects. The method also includes pointing to at least one of the one or more icons with a pointing device to activate the at least one icon. The method further comprises providing a photograph of the one or more still objects represented by the at least one icon on the display device.

### BRIEF DESCRIPTION OF FIGURES

These and other characteristics of the present invention will be more fully understood by reference to the following detailed description in conjunction with the attached drawings, in which:

FIG. 1A illustrates an exemplary diagramming tool that can be used with various embodiments of the present invention;

FIG. 1B illustrates an exemplary feature of the exemplary diagramming tool that can be used with various embodiments of the present invention;

FIG. 1C illustrates another exemplary feature of the exemplary diagramming tool that can be used with various embodiments of the present invention;

FIG. 2 illustrates a flow chart of steps to generate an exemplary diagram of a motor vehicle collision using the exemplary diagramming tool;

FIG. 3A illustrates a first exemplary diagram of a motor vehicle collision generated using the exemplary diagramming tool;

FIG. 3B illustrates a second exemplary diagram of a motor vehicle collision generated using the exemplary diagramming tool;

FIG. 3C illustrates a third exemplary diagram of a motor vehicle collision generated using the exemplary diagramming tool;

FIG. 4 illustrates a user submitting a complete insurance claim application to one or more insurance providers;

FIG. 5A-5B illustrates a flow chart of steps to submit a complete insurance claim application with one or more insurance providers using the exemplary diagramming tool provided by a service provider;

FIG. 6A illustrates a map of a geographical location and a plurality of traffic signs on the geographical location;

FIG. 6B illustrates providing information about a location of a traffic sign on the map of FIG. 6A;

FIG. 6C illustrates a photograph of the location of the traffic sign on the map of FIG. 6B; and

FIG. 7 illustrates a flow chart of steps to retrieve a photograph of a location of a traffic sign on a geographical location.

### DETAILED DESCRIPTION

Personal injury and property damage claims that result from motor vehicle accidents are submitted to the insurance companies to claim damages resulting from the accidents. A complete insurance claim application requires an application form and a graphical depiction, e.g., a drawing, illustrating the incident. Different insurance companies may have additional requirements, such as photographs showing the incident site, personal statements, etc.

Currently, it is possible to submit an insurance claim application in electronic form with some of the insurance provider companies. The present invention provides a diagramming tool software application that enables an insured to generate a graphical representation (i.e. drawings) of the incident to be submitted along with the insurance claim application form. This submission can be done in an online environment, including but not limited to the Internet. This streamlines the claim application process, and reduces errors stemming from the insurance adjuster being required to associate the drawings with the claims, and/or re-create the drawings in a more legible and/or transferable format.

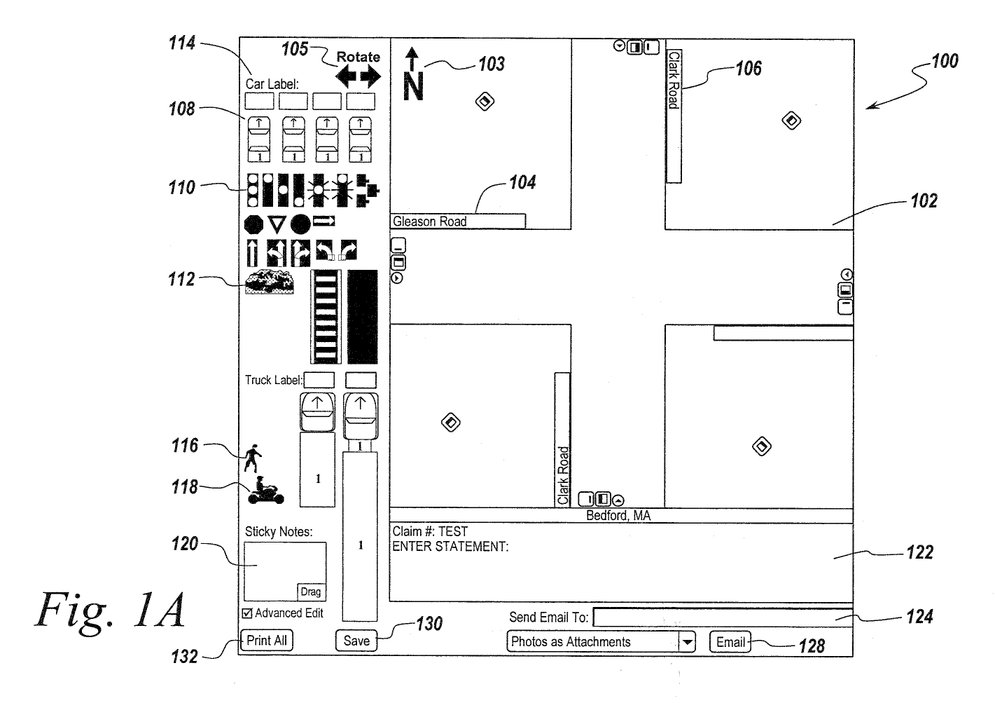

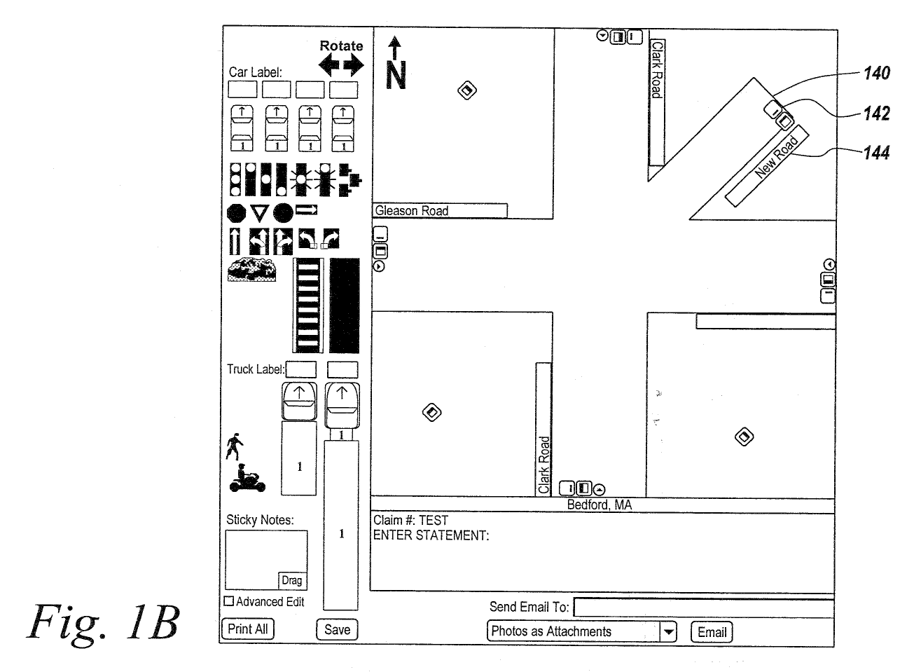

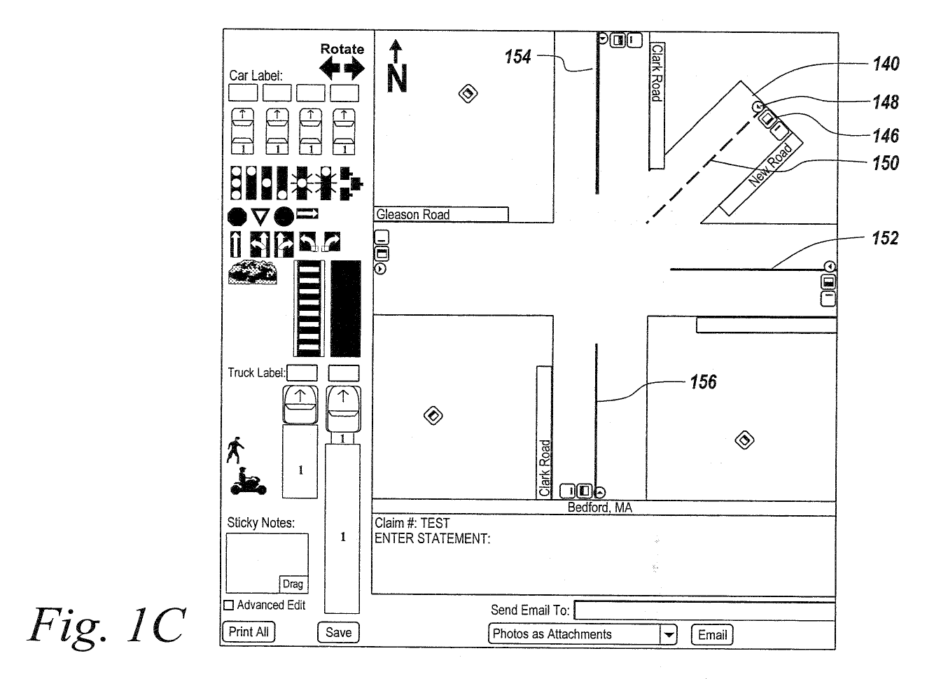

As illustrated in FIG. 1A, the diagramming tool has a graphical user interface (GUI) 100 that enables a user, e.g. the insured, to generate a diagram of the incident. The diagramming tool has a mapping tool and a shapes tool. The mapping tool is used to generate a diagram of the location, including but not limited to, streets, intersections, roundabouts, etc. The shapes tool is used to populate the diagram of the location with still or mobile objects that were present at the incident time. The shapes tool may have pre-designed shapes to illustrate people, cars, traffic signs, etc. The shapes tool may also enable a user to generate shapes using a hand sketching tool. The GUI 100 displays a diagram 102, e.g. a map, of the geographical location to the user. According to one embodiment of the present invention, the diagram 102 may only illustrate a plurality of streets 104, 106 of the geographical location and the user may be required to populate the diagram 102 with the objects present at the location. According to another embodiment of the present invention, the diagram 102 may illustrate all static objects, such as traffic signs and landscape elements that are present at the location. The diagram 102 may also indicate at least one cardinal direction 103 on the map to give a better sense of the geographical location. The GUI 100 may accept an indication of the geographical location of the areas (e.g., based on address or GPS coordinates) and automatically generate elements of the diagram 102 associated with that location. One of ordinary skill in the art will appreciate that a number of different variations as to what is automatically depicted in the map as it portrays a particular geographic location are possible, and that the present invention is not limited to the specific examples described herein.

The diagramming tool provides a plurality of icons that represent a plurality of objects present at the location at the time of the incident. For example, the diagramming tool may have a plurality of car icons 108 representing the automobiles at the incident location. Visual markers such as colors, numbers, shapes or symbols may be associated with the icons to distinguish similar icons from each other. In addition, a label 114 may be added to each car icon 108 to further identify the automobile represented by the car icon 108. The diagramming tool also provides a rotate 105 option that enables the user to better position each icon.

The diagramming tool may further provide traffic sign icons 110 representing traffic signs, including but not limited to traffic lights, stop signs, and direction signs. The diagramming tool may also provide a plurality of icons, including but not limited to landscape icons 112 representing landscape elements, people icons 116 representing people and motorcycle icons 118 representing motorcycles. The icons represented in this application are for illustrative purposes and should not be construed as limiting. Additional icons may be added to the diagramming tool, including but not limited to, weather icons, animal icons, emergency assistance vehicle icons (such as fire truck icons, emergency medical services (EMS) icons, police car icons), and the like.

The diagramming tool may further provide a text area 122 and sticky notes 120 that enable the user to add narrative statements to the diagram 102 to better explain the incident. The text area 122 and sticky notes 120 may be used to illustrate details that cannot be included on the diagram 102 using the icons of the diagramming tool. The diagramming tool may present various commands to save 130, print 132 and email 128 the diagram 102 generated by the user using the diagramming tool.

As illustrated in FIG. 1B, the diagramming tool may enable the user to modify the diagram 102 by adding one or more new streets 140 using a widget 142. The diagramming tool also enables the user to add a label 144 to the new street 140. As used herein, the term “street” encompasses roads, driveways and other public and private ways accessible to motor vehicles.

The diagramming tool also enables the user to further customize the diagram by changing the width of the streets using a widget 146 as illustrated in FIG. 1C. The user may further add street lines 150, 152, 154 and 156 to the streets of the diagram to illustrate the lanes of the streets using a widget 148.

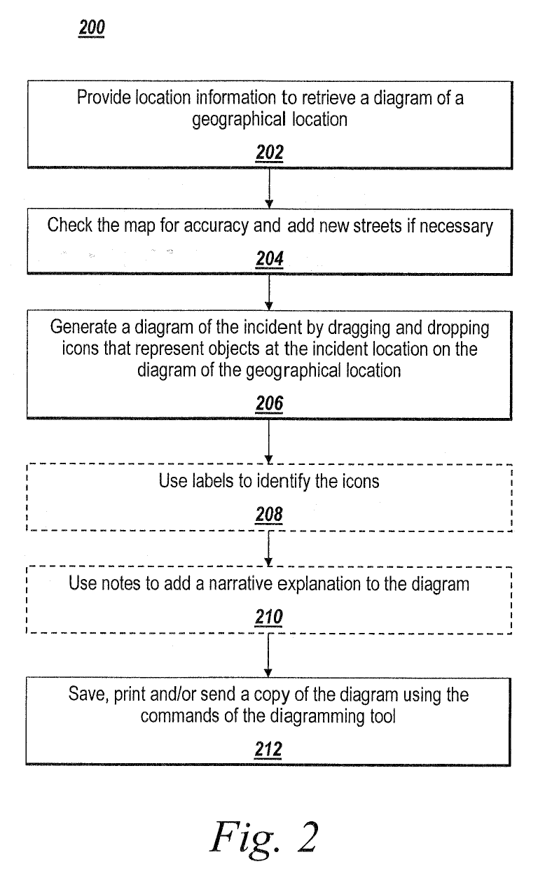

FIG. 2 illustrates a flow chart 200 of steps to generate an exemplary diagram of an incident using the exemplary diagramming tool. In accordance with one example embodiment of the present invention, the user can provide location information to retrieve a diagram of a geographical location (step 202). For example, the user may provide a state name or a state acronym, a city name, a zip code, or an address. The diagramming tool may present drop down menus for the user to select the location information. Alternatively, the user may directly type the location information on a text area provided by the diagramming tool. Once the diagram of the geographical location is retrieved, the user may check the diagram for accuracy (step 204). If necessary, the user can add one or more streets to the diagram using the options provided by the diagramming tool (step 206). The user then generates a diagram of the incident by dragging and dropping icons that represent objects at the incident location on the diagram of the geographical location (step 206). Optionally, the user may use labels to further identify the icons representing the objects at the incident location (step 208). Labels may be effective in distinguishing the icons representing the same type of objects, such as motor vehicles. The user may choose to add narrative detail to the diagram (step 210). The narrative detail may be useful when the user deems that the graphical icons are not enough to illustrate the conditions at the incident location. Upon completing the diagram, the user may save, print or e-mail the diagram using various commands of the diagramming tool (step 212). Alternatively, the user may attach the diagram to an insurance claim form and submit the insurance claim form along with the diagram to one or more insurance providers via an online connection, such as the Internet.

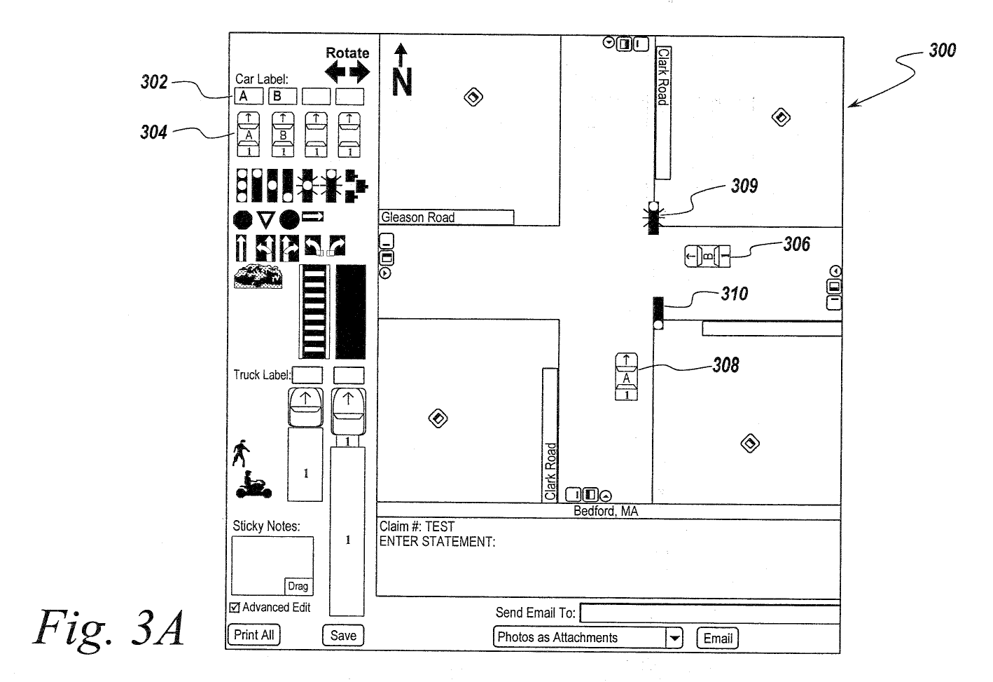

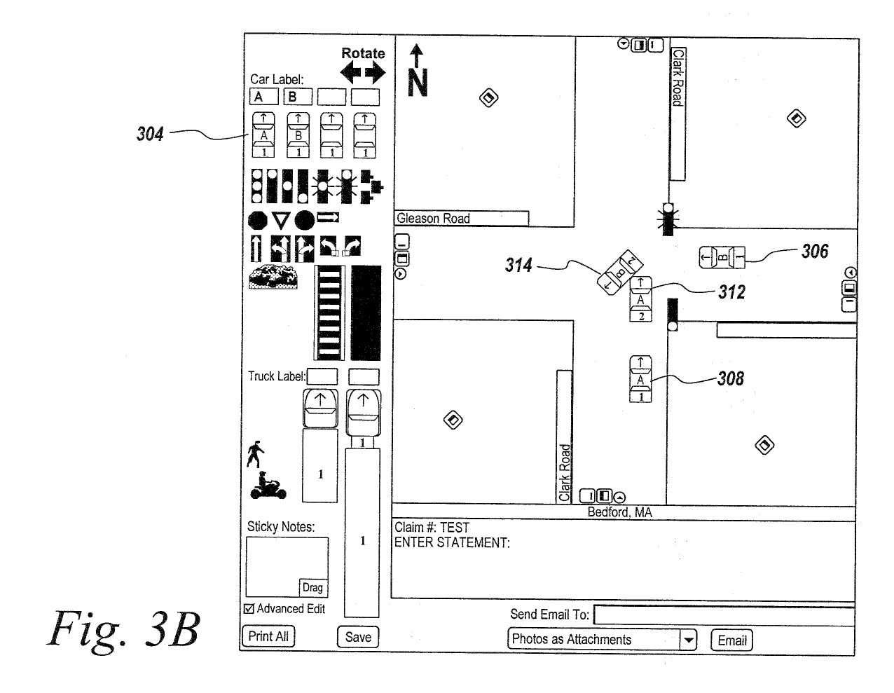

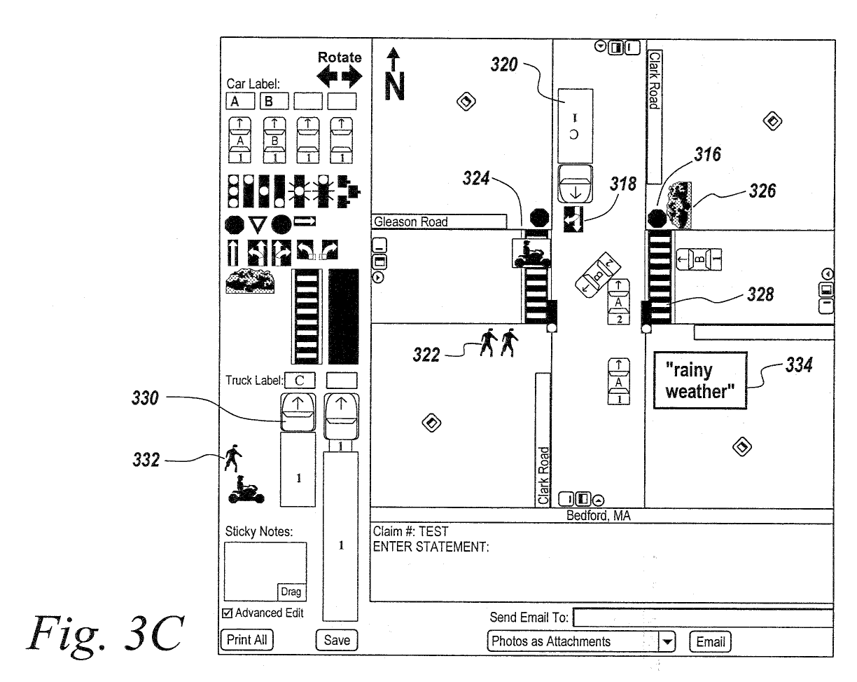

FIGS. 3A-3C illustrate an exemplary diagram generated using the diagramming tool in accordance with one embodiment of the present invention. FIG. 3A shows a diagram 300 with a plurality of graphical icons. The diagram 300 includes a first car icon 306 representing a first automobile and a second car icon 308 representing a second automobile at an intersection. The traffic light icons 309 and 310 illustrate that the light for the second vehicle is red and the light for the first vehicle is green. The first car icon 306 is labeled “A” and the second car icon 308 is labeled “B” using the label icons 302 of the diagramming tool. The first instance of the first car icon 306 is further designated with numeric cue “1”. Similarly, the first instance of the second car icon 308 is designated with numeric cue “1”. If the user introduces a second instance of the first and second car icons 306 and 308, the icons 304 will be designated with numeric cue “2”.

FIG. 3B illustrates the diagram having multiple instances of the first and second automobiles. The first position of the first car icon 306 and the first position of the second car icon 308 are designated with numeric cue “1”. Similarly, the second position of the first car icon 306 and the second position of the second car icon 308 are designated with numeric cue “2”. If the user chooses to introduce additional instances, the subsequent instances will be illustrated with numeric cues of increasing numbers 304. Using multiple instances of the first and second automobiles, FIG. 3B illustrates how the incident happened. According to an option, the graphical representation may include one or more arrows representing the moving directions of the icons representing the motor vehicles or the people.

The user may choose to add more details to the diagram or modify the existing details. FIG. 3C illustrates that the traffic signs at the incident location illustrated in FIG. 3B have been modified. The user removed the traffic light 309 and replaced it with a stop sign icon 316. The user also added a pedestrian crossing 328, a landscape element 326, pedestrians 322, a motorist 324, a truck 320 labeled “C”, a road sign 318 and a sticky note 334 to the diagram. The sticky note 334 further indicates the weather conditions at the time of the incident. As illustrated on FIG. 3C, if the user wishes to add another pedestrian in the diagram, the pedestrian icon 332 will be numbered “3” since there are already two pedestrian icons 322 in the diagram. Similarly, if the user wishes to add a second truck labeled “C”, the truck icon 330 will be numbered “2” since there is already one truck icon 320 in the diagram.

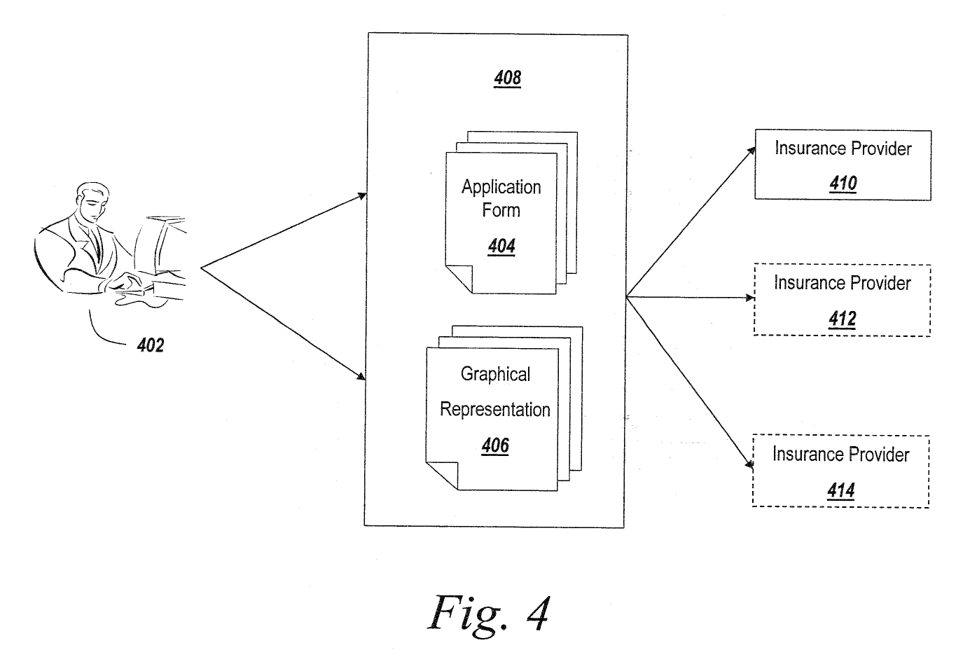

A user can generate an insurance claim and the corresponding graphical representation using the diagramming tool. As illustrated in FIG. 4, the user 402 may generate an insurance claim application form 404 using a computing device. The user 402 may also generate the corresponding graphical representation 406 using the computing device. The graphical representation 406 comprises at least one representation of the insured individual or a vehicle of the insured. The graphical representation 406 can also include icons representing one or more objects present at the incident location. The insurance claim application form 404 and the corresponding graphical representation 406 together form a complete insurance claim application 408. The user may then submit the complete insurance claim application 408 with one or more insurance providers 410, 412 and 414. The submission of the complete insurance claim application may be completed online, e.g. via Internet. As illustrated in FIG. 4, submitting the insurance claim application 408 with more than one insurance provider is optional.

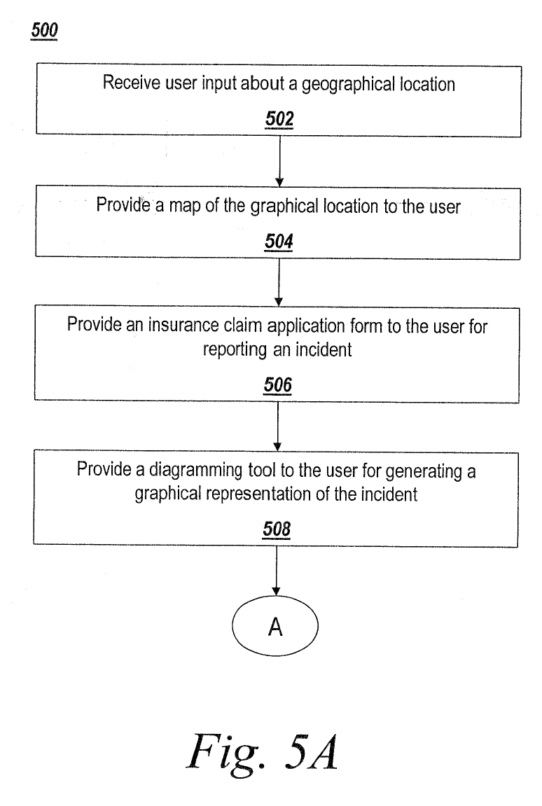

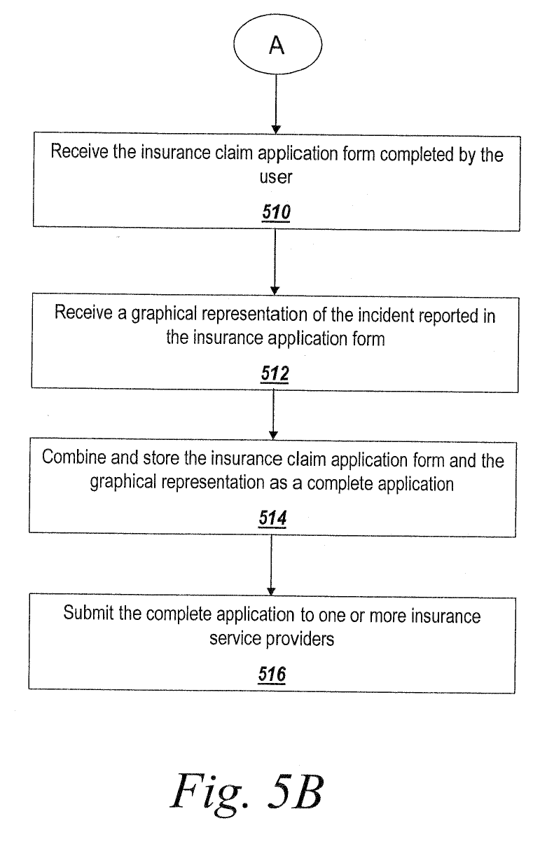

The user may use an insurance provider's website or a service provider with online access to generate and submit the insurance claim application. FIGS. 5A-5B illustrate a flowchart 500 of steps for generating and submitting an insurance claim application. The service provider receives the user input concerning a geographical location (step 502). The user input concerning the geographical representation may include, but is not limited to, a state name, a city name or a street name. Upon the user's request, the service provider provides a map of the geographical location to the user (step 504). The service provider also provides an insurance claim application form to the user for reporting an incident (step 506). The insurance claim application form can be insurance service provider specific, or it can be a standardized form used in similar applications. In accordance with example embodiments of the present invention, the service provider also provides a diagramming tool to the user for generating a graphical representation of the incident referred to in the insurance claim application form (step 508). The user fills out the insurance claim application form and electronically generates a graphical representation of the incident as discussed above with respect to FIG. 4. The service receives the complete insurance claim application including the claim application form and the graphical representation (steps 510 and 512). The service provider electronically combines the claim application form and the graphical representation to form a complete insurance claim application and electronically stores the complete insurance claim application (step 514). The user can change the information entered on the form or on the graphical representation one or more times before submitting the application online with one or more insurance providers. Certain insurance providers may also allow the user to make changes to the application after submitting the application. Once the user is satisfied with the application, the user may instruct the service provider to submit the complete application with one or more insurance service providers (step 516). The complete application may be submitted online, e.g. via Internet, with the service providers.

According to one embodiment of the present invention, the user may enter location information to retrieve a map of the location. Various traffic signs, including but not limited to speed limit signs, may be indicated on the map using an activatable icon hyperlinked to a photograph of the traffic sign.

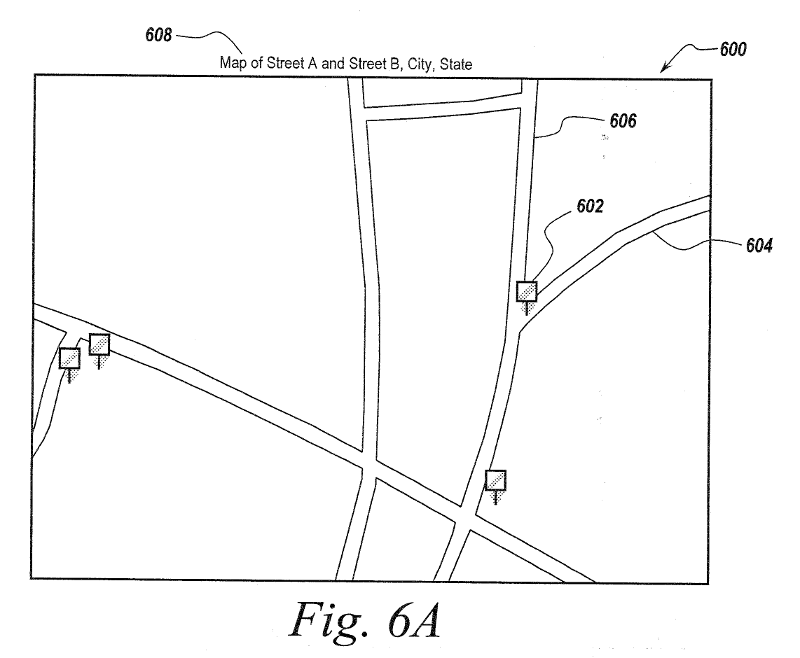

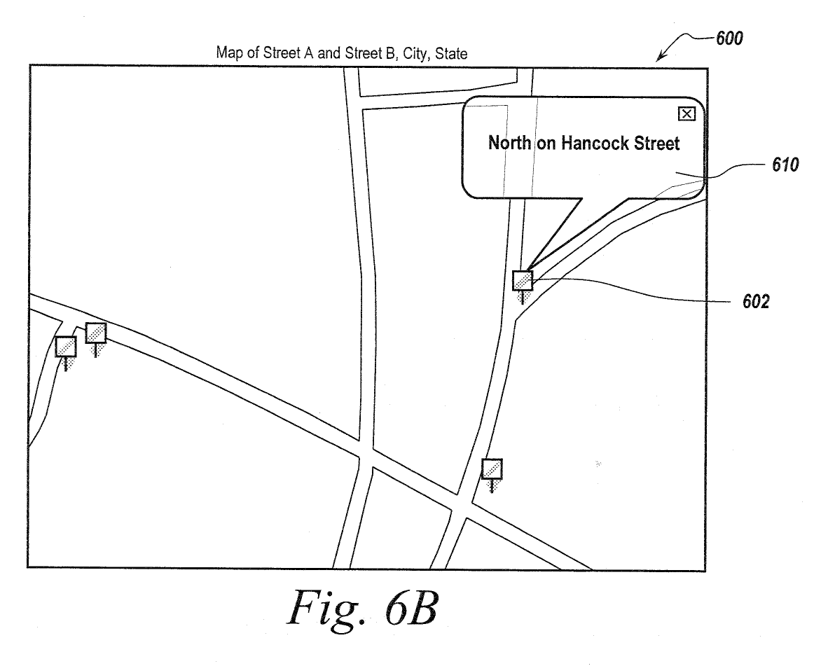

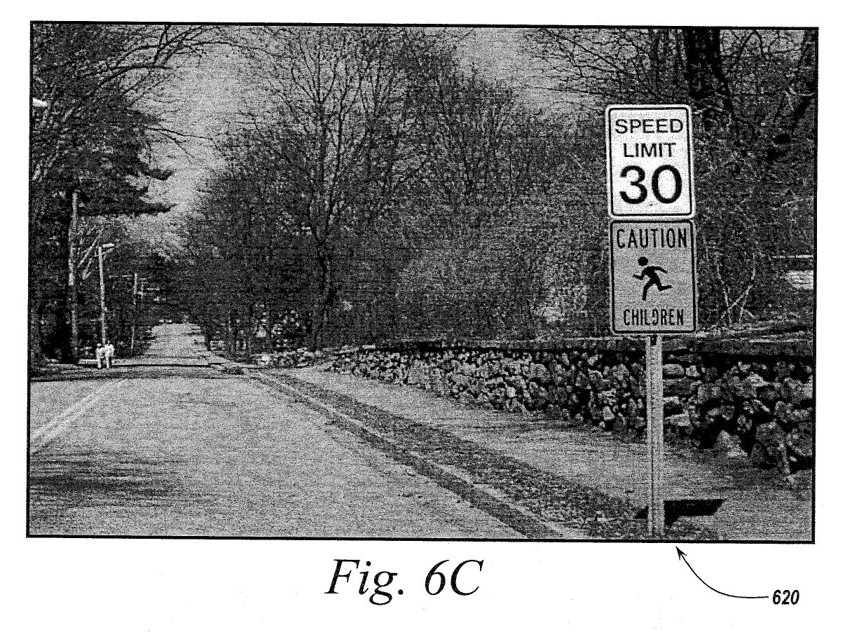

FIG. 6A illustrates a map 600 with a plurality of traffic sign icons 602. The map may illustrate the streets 604 and 606 of the geographical location requested by the user, or resulting from an indication of address or the like. The map may also indicate the geographical location 608 along with the map 600. The user may activate the icon 602 using a pointing device such as a mouse, a keyboard, a trackball, a touchpad or a touchscreen.

As illustrated in FIG. 6B, the icon 602 may display information 610 about the photograph of the traffic sign when the user points to the icon using the pointing device. For example, the icon 602 may display a direction of the photograph. Once the user activates the icon 602 using the pointing device, a photograph 620 of the traffic sign represented with the icon 602 is provided to the user as illustrated in FIG. 6C. Thus, by using this feature of the diagramming tool in accordance with the present invention, a user is alerted as to the existence of traffic signs, such as speed limit signs, and their location along a street. Then, by clicking on the traffic icon 602, the user is immediately provided with an actual photograph 620 of the actual traffic sign and how it looks on the street. This information can be very useful when it relates to an incident, because the photograph could highlight realities that are not able to be reflected in the computer generated re-creations of the street (such as by typical mapping programs). Furthermore, this feature of the present invention differs from mapping software applications that provide routine photographs of a street, or of consecutive sections of a street, which may or may not capture traffic signs incidentally. The present invention provides additional information and utility by inserting the traffic sign icon 602 on the computer-generated map 600 of the location to highlight the existence of the sign. Then, as the map is reviewed, the user is easily able to recognize the existence of the particular traffic signs depicted with icons, and then click on those icons to get a true photographic image focused on the traffic sign itself. When used along with the diagramming tool, this feature provides additional information about the incident location. The photograph may also be used to check the accuracy of the diagram generated by the user with the diagramming tool.

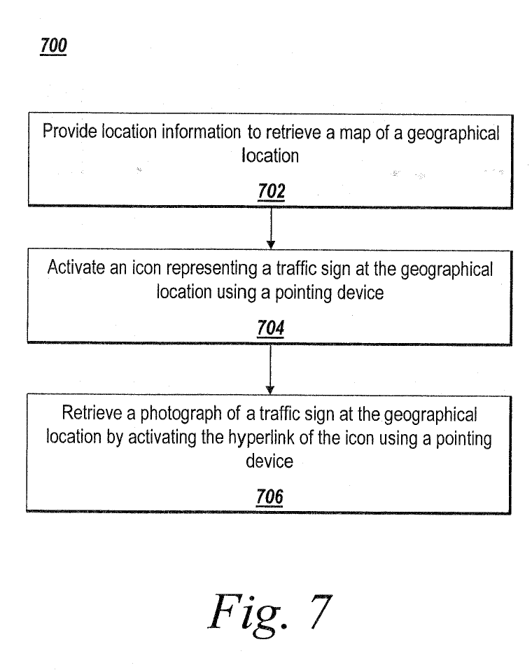

FIG. 7 illustrates a flow chart 700 of steps to access a photograph of a traffic sign present at the incident location. First, the user provides location information to retrieve a map of a geographical location (step 702). For example, the user may provide a state name or a state acronym, a city name, a zip code, or an address. The map provided to the user may include a plurality of icons representing traffic signs at the geographical location. The user may activate an icon representing a traffic sign using a pointing device (step 704). Upon activation, a photograph of a traffic sign is provided to the user (step 706). The icon may be hyperlinked to the photograph to easily retrieve and display the photograph.

The present invention provides an application, such as a software application, for submitting a complete insurance claim application to one or more insurance providers. The complete insurance claim application may be submitted online to the insurance providers. A complete insurance claim application includes, at a minimum, an insurance claim application form and a drawing representing the incident for which the claim is being filed. Using the software tool described above, the user can easily represent the details of the incident. The software tool is user-friendly and is designed to include elements that the user may wish to incorporate in the graphical representation. The graphical representation generated using the software tool is customizable: the user may change the elements of the graphical representation as he/she wishes. Furthermore, the software tool standardizes the graphical representations submitted with insurance claims. Thus, the present invention eliminates the burden on the insurance claim assessor who often have to form their own interpretation of the elements of the drawing of the incident, or have to generate the drawing themselves based on the description provided by the insured. The method and tools described herein help the insurance industry to improve the insurance claim application and assessment process.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the diagramming tool may vary substantially without departing from the spirit of the invention, and exclusive use of all modifications that come within the scope of the appended claims is reserved.

What is claimed is:

1. A computer implemented method for submission of a motor vehicle insurance claim relating to an incident to one or more insurance service providers, the method comprising:
receiving an insurance claim application form containing information concerning the incident;
receiving a graphical representation of the incident in electronic form prepared using a diagramming software tool, the graphical representation comprising at least one representation of an insured individual or a vehicle of the insured individual;
storing the insurance claim application form and the graphical representation of the incident as a completed insurance claim application; and
submitting the completed insurance claim application to the one or more insurance service providers.

2. The computer implemented method of claim 1, wherein the completed insurance claim application is submitted online.

3. The computer implemented method of claim 1, further comprising providing an insurance claim application form that requires information be added by a user for completion.

4. The computer implemented method of claim 1, further comprising providing the diagramming software tool for preparation of the graphical representation of the incident.

5. The computer implemented method of claim 1, further comprising:
receiving information about a location of the incident using the diagramming software tool, the information comprising one or more of a state, a city, or a street name; and
displaying a map of the location or a diagram of the location.

6. The computer implemented method of claim 5, wherein the information about the location is received from the insurance claim application form containing information concerning the incident.

7. The computer implemented method of claim 1, wherein the graphical representation comprises representation of one or more objects present at a location of the incident using one or more icons, the one or more objects comprising signs, motor vehicles, people, natural objects, or man-made objects.

8. The computer implemented method of claim 7, wherein if the one or more icons represent a same type of object, each of the one or more icons further comprises a visual marker for differentiation.

9. The computer implemented method of claim 8, wherein the visual marker comprises one or more of a number, a color, or a symbol.

10. The computer implemented method of claim 7, wherein the diagramming software tool enables relocation or rotation of the one or more icons representing the one or more objects present at the location of the incident to accurately represent the incident.

11. The computer implemented method of claim 10, wherein the one or more icons are relocated or rotated using a pointing device.

12. The computer implemented method of claim 7, wherein the diagramming software tool enables labeling of the one or more icons representing the one or more objects present at the location of the incident to accurately represent the incident.

13. The computer implemented method of claim 7, further comprising the graphical representation identifying the one or more icons using one or more labels.

14. The computer implemented method of claim 7, wherein at least one icon comprises an arrow indicating a moving direction of one or elements represented by the at least one icon.

15. The computer implemented method of claim 1, wherein the graphical representation includes a representation of an initial location and a representation of a final location of the insured individual or the vehicle of the insured individual, and a representation of an initial location and a representation of a final location of a collision object.

16. The computer implemented method of claim 15, wherein the graphical representation further includes at least one representation of intermediary locations of the insured individual or the vehicle of the insured individual and the collision object, wherein the at least one representation of the intermediary locations comprises a representation of locations between the initial locations and the final locations.

17. The computer implemented method of claim 1, wherein the completed insurance claim application further comprises a photograph of a location of the incident.

18. The computer implemented method of claim 1, wherein the completed insurance claim application further comprises a plurality of graphical representations in electronic form representing a sequence of a plurality of events representing the incident.

19. The computer implemented method of claim 18, wherein the plurality of graphical representations is combined in the sequence of the plurality of events creating a motion picture of the incident.

20. The computer implemented method of claim 1, wherein the graphical representation comprises an indication of a cardinal direction.

21. The computer implemented method of claim 1, wherein the diagramming software tool comprises the function of labeling objects of the graphical representation.

22. The computer implemented method of claim 1, wherein the diagramming software tool comprises the function of adding one or more line markings to objects on the graphical representation using a widget.

23. A computer implemented storage medium, the medium storing:
a graphical diagramming tool for generating a graphical representation of a motor vehicle incident, the graphical diagramming tool comprising:
a mapping tool for generating a diagram of a location of the motor vehicle incident;
a shapes tool for generating one or more icons representing one or more objects present at the location of the motor vehicle incident, the one or more objects comprising signs, motor vehicles, people, natural objects, or man-made objects; and
an insurance claim application tool for filling out an insurance claim application form, wherein the graphical diagramming tool interacts with the insurance claim application tool.

24. A computer implemented method of providing a photograph of an object at a geographical location on a display device, the method comprising:
providing a graphical representation of the geographical location on the display device, the graphical representation comprising one or more icons representing one or more still objects present at the geographical location, the one or more objects comprising signs, natural objects, or man-made objects;
pointing to at least one of the one or more icons with a pointing device to activate the at least one icon; and
providing a photograph of the one or more still objects represented by the at least one icon on the display device.

25. The computer implemented method of claim 24, wherein the one or more objects comprise a speed limit sign or a traffic sign.
